(19) United States
(12) Patent Application Publication
(10) Pub. No.: US 2008/0096780 A1
(43) Pub. Date: Apr. 24, 2008

(54) Liquid Detergent Compositions and Their Use

(76) Inventors: Marcel Henricus Gerardus Veugelers, Vlaardingen (NL); Vidyadhar Sudhir Ranade, Rotterdam (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 11/794,022

(22) PCT Filed: Nov. 7, 2005
(86) PCT No.: PCT/EP05/11969

§ 371 Date: Jun. 21, 2007

(30) Foreign Application Priority Data
Dec. 23, 2004 (EP) 04078510.7

(51) Int. Cl. C11D 17/00; C11D 17/04; C11D 3/43; C11D 3/50

(52) U.S. Cl. 510/101; 510/405

(57) ABSTRACT

A substantially non-aqueous liquid detergent composition which comprises: (a) perfume microcapsules; (b) no more than 20%, preferably no more than 15%, still more preferably no more than 10% by weight of water; (c) from 10% to 70%, preferably from 20% to 60% by weight of water-miscible organic solvent having a molecular weight greater than 70; and (d) from 30% to 90%, preferably from 40% to 80% by weight of one or more components comprising alkyl or alkenyl chains having more than 6 carbon atoms.

### FIELD OF THE INVENTION

The present invention relates to substantially non-aqueous liquid detergent compositions and their use.

### BACKGROUND OF THE INVENTION

Commercial cleaning products generally have aroma or fragrance chemicals in them to enhance their performance and attractiveness. These are commonly referred to as “perfumes”. Since such perfumes are composed of one or more relatively volatile ingredients, in solid detergent compositions, they tend to leak out during storage of detergents thus reducing their effectiveness. However, in liquid detergent compositions it is necessary to protect sensitive perfume ingredients from the surrounding formulation. Another problem associated is they tend to evaporate too fast from the surfaces on which they need to be deposited during a cleaning process. It is widely known that deposition of perfume on to surfaces to be cleaned can be greatly enhanced by using particles in which the perfume is trapped, absorbed or encapsulated. These particles also cue cleanliness for a longer time because they slowly release perfume after cleaning.

Such particles are made either by supporting the fragrance on a water-insoluble porous carrier or by encapsulating the fragrance in a water-insoluble shell. In the latter category microencapsulates of perfume made by precipitation and deposition of polymers at the interface such as in coacervates, for example as disclosed in GB-A-0 751 600, U.S. Pat. No. 3,341,466 and EP-A-0 385 534, or other polymerisation routes such as interfacial condensation U.S. Pat. No. 3,577,515, US-A-2003/0125222, U.S. Pat. No. 6,020,066, WO2003/101606, U.S. Pat. No. 5,066,419. A particularly useful means of encapsulation is using the melamine/urea—formaldehyde condensation reaction as described in U.S. Pat. No. 3,516,941, U.S. Pat. No. 5,066,419 and U.S. Pat. No. 5,154,842. Such capsules are made by first emulsifying perfume in small droplets in a pre-condensate medium obtained by the reaction of melamine/urea and formaldehyde and then allowing the polymerisation reaction to proceed along with precipitation at the oil-water interface. The encapsulates ranging in size from a few micrometer to a millimeter are then obtained in a suspension form in an aqueous medium.

There are numerous disclosures concerning the use of particles in non-aqueous liquids, especially for unit dose applications, e.g., WO-A-2003/48293 and WO-A-02/057402.

Incorporation of such core-in-shell encapsulates in detergent powders is relatively straightforward. The capsule slurries can be mixed with the detergent as is known from U.S. Pat. No. 5,066,419 or spray dried and then blended with detergent granules as described in US-A-2003/0125222. Incorporation in aqueous liquids is however very challenging because perfume from capsules leaks out into the liquids. Perfume is probably extracted out of the capsules because perfume also mixes well in the environment of the surfactant micelles present in the composition. In substantially non-aqueous liquids one would expect the problem to worsen further because perfume is very well soluble in the polar liquids that are used as solvents in non-aqueous liquids.

Surprisingly, however, we have found that perfume microcapsules, especially melamine-formaldehyde microcapsules are especially stable in substantially non-aqueous liquid detergents having a composition as defined below.

### DEFINITION OF THE INVENTION

Thus, a first aspect of the present invention provides a substantially non-aqueous liquid detergent composition which comprises:
(a) perfume microcapsules;
(b) no more than 20%, preferably no more than 15%, still more preferably no more than 10% by weight of water;
(c) from 10% to 70%, preferably from 20% to 60% by weight of water-miscible organic solvent having a molecular weight greater than 70; and
(d) from 30% to 90%, preferably from 40% to 80% by weight of one or more components comprising alkyl or alkenyl chains having more than 6 carbon atoms.

A second aspect of the present invention provides a method of cleaning a fabric by contacting said fabric with an aqueous wash liquor in which a composition according to the first aspect of the invention is dissolved and/or dispersed.

### DETAILED DESCRIPTION OF THE INVENTION

The Perfume Microcapsules

Compositions according to the invention comprise perfume microcapsules, eg in amount up to 20%, preferably up to 10% by weight of the perfume component (including any liquid carrier) based upon the weight of the final composition. The minimum amount (based on weight of the perfume including any liquid carrier) is preferably 0.001%, more preferably 0.01%, still more preferably 0.1% by weight of the final composition.

The preferred perfume microcapsules utilised in the present invention are core-in-shell microcapsules.

As used herein, the term core-in-shell microcapsules refers to encapsulates whereby a shell which is substantially or totally water-insoluble at 40° C. surrounds a core which comprises or consists of perfume (including any liquid carrier therefor).

One preferred class of core-in-shell perfume microcapsule comprises those generally of the kind described in U.S. Pat. No. 5,066,419. As mentioned above, these comprise a core having from about 5% to about 50% by weight of perfume dispersed in from about 95% to about 50% by weight of a carrier material. This carrier material is a non-polymeric solid fatty alcohol or fatty ester carrier material, or mixtures thereof. The esters or alcohols have a molecular weight of from about 100 to about 500 and a melting point from about 37° C. to about 80° C. The alcohols or esters are substantially water-insoluble. The core comprising the perfume and the carrier material are coated in a substantially water-insoluble coating on their outer surfaces. The microcapsules recited in U.S. Pat. No. 5,066,419 are indicated as having an average particle size less than about 350 microns, preferably less than 150 microns. For the avoidance of doubt, in the context of the present invention, core-in-shell microcapsules preferably have a d_{4,3} average particle size of from 0.01μ to 200μ more preferably from 1μ to 100μ. Similar microcapsules are disclosed in U.S. Pat. No. 5,154,842 and these are also suitable.

The microcapsules as described in U.S. Pat. No. 5,066,419 have a friable coating which is preferably an aminoplast polymer. Preferably, the coating is the reaction product of an amine selected from urea and melamine, or mixtures thereof, and the aldehyde selected from formaldehyde, acetaldehyde, glutraraldehyde or mixtures thereof. Preferably, the coating is from 1 to 30% by weight of the particles. The carrier material preferably comprises an alcohol selected from the C₁₄-C₁₈ alcohols or an ester comprising at least 18 carbon atoms.

Core-in-shell perfume microcapsules of other kinds are also suitable for use in the present invention. Ways of making such other microencapsulates of perfume include precipitation and deposition of polymers at the interface such as in coacervates, as disclosed in GB-A-751 600, U.S. Pat. No. 3,341,466 and EP-A-385 534, as well as other polymerisation routes such as interfacial condensation, as described in U.S. Pat. No. 3,577,515, US-A-2003/0125222, U.S. Pat. No. 6,020,066 and WO-A-03/101606. Microcapsules having polyurea walls are disclosed in U.S. Pat. No. 6,797,670 and U.S. Pat. No. 6,586,107.

Other patent applications specifically relating to use of melamine-formaldehyde core-in-shell microcapsules in aqueous liquids are WO-A-98/28396, WO02/074430, EP-A-1 244 768, US-A-2004/0071746 and US-A-2004/0142868.

The Substantially Non-Aqueous Liquid Detergent Composition

The substantially non-aqueous liquid detergent composition must contain at least one non-aqueous liquid. Further, the non-aqueous liquid itself and/or another component of the composition must provide detergency i.e. a cleaning function.

Compositions according to the present invention comprise 20%, more preferably no more than about 15%, still more preferably no more from 10%, such as no more than about 7%, even more preferably no more than about 5% by weight of water. Still lower water contents are also possible such as no more than from about 3% to about 4%, by weight, or even total absence of water, although levels below 5% are less preferred.

The substantially non-aqueous liquid detergent composition may be substantially Newtonian or else non-Newtonian in rheology. The latter especially applies when the composition comprises dispersed solids. For the avoidance of doubt, all viscosities expressed herein are measured at a shear rate of 21 s⁻¹.

The viscosity of the composition is preferably greater than 200 mPas at a shear rate of 21 s⁻¹.

The composition may be considered as falling into the sub-classes of thin liquids, thick liquids, and gels/pastes.

Compositions according to the present invention must contain from 30% to 90%, preferably from 40% to 80% by weight of material selected from one or more components comprising alkyl or alkenyl chains having more than 6 carbon atoms. These do not necessarily have to be liquids but one suitable class of such material comprises the liquid nonionic surfactants. Any reference herein to alkyl or alkenyl refers to either of theses moieties in straight or branched form unless the context dictates to the contrary.

Nonionic detergent surfactants are well-known in the art. They normally consist of a water-solubilizing polyalkoxylene or a mono- or d-alkanolamide group in chemical combination with an organic hydrophobic group derived, for example, from alkylphenols in which the alkyl group contains from about 6 to about 12 carbon atoms, dialkylphenols in which primary, secondary or tertiary aliphatic alcohols (or alkyl-capped derivatives thereof, preferably having from 8 to 20 carbon atoms, monocarboxylic acids having from 10 to about 24 carbon atoms in the alkyl group and polyoxypropylense. Also common are fatty acid mono- and dialkanolamides in which the alkyl group of the fatty acidradical contains from 10 to about 20 carbon atoms and the alkyloyl group having from 1 to 3 carbon atoms. In any of the mono- and di-alkanolamide derivatives, optionally, there may be a polyoxyalkylene moiety joining the latter groups and the hydrophobic part of the molecule. In all polyalkoxylene containing surfactants, the polyalkoxylene moiety preferably consists of from 2 to 20 groups of ethylene oxide or of ethylene oxide and propylene oxide groups. Amongst the latter class, particularly preferred are those described in the applicants' published European specification EP-A-225,654, especially for use as all or part of the solvent. Also preferred are those ethoxylated nonionics which are the condensation products of fatty alcohols with from 9 to 15 carbon atoms condensed with from 3 to 11 moles of ethylene oxide. Examples of these are the condensation products of C₁₁₋₁₃ alcohols with (say) 3 or 7 moles of ethylene oxide. These may be used as the sole nonionic surfactants or in combination with those of the described in the last-mentioned European specification, especially as all or part of the solvent.

Another class of suitable nonionics comprise the alkyl polysaccharides (polyglycosides/oligosaccharides) such as described in any of specifications U.S. Pat. Nos. 3,640,998; 3,346,558; 4,223,129; EP-A-92,355; EP-A-99,183; EP 70,074, '75, '76, '77; EP 75,994, '95, '96.

Nonionic detergent surfactants normally have molecular weights of from about 300 to about 11,000. Mixtures of different nonionic detergent surfactants may also be used, provided the mixture is liquid at room temperature.

One or more fatty alcohols and/or fatty acid esters may also be included.

Compositions according to the present invention must also comprise from 10% to 70%, preferably from 20% to 60% by weight of water-miscible organic solvent having a molecular weight greater than 70. This water-miscible organic solvent component may consist of one or more such solvents.

Preferred such solvents include ethers, polyethers, alkylamines and fatty amines, (especially di- and tri-alkyl- and/or fatty-N-substituted amines), alkyl (or fatty) amides and mono- and di-N-alkyl substituted derivatives thereof, alkyl (or fatty) carboxylic acid lower alkyl esters, ketones, aldehydes, polyols, and glycerides. Specific examples include respectively, di-alkyl ethers, polyethylene glycols, alkyl ketones (such as acetone) and glyceryl trialkylcarboxylates (such as glyceryl tri-acetate), glycerol, propylene glycol, and sorbitol.

Other suitable solvents include higher (C₅ or more, eg C₅-C₉) alkanols such as hexanol. Lower (C₁-C₄) alkanols are also useable although they are less preferred and therefore, if present at all, are preferably used in amounts below 20% by weight of the total composition, more preferably less than 10% by weight, still more preferably less than 5% by weight. Alkanes and olefins are yet other suitable solvents. Any of these solvents can be combined with solvent materials which are surfactants and non-surfactants having the aforementioned “preferred” kinds of molecular structure. Even though they appear not to play a role in the deflocculation process, it is often desirable to include them for lowering the viscosity of the product and/or assisting soil removal during cleaning.

The weight ratio of component (d), ie materials with >C₆ alkyl or alkenyl chains to component (c), ie water-miscible organic solvent with MW>70 is preferably from 1:10 to 10:1, more preferably from 1:6 to 6:1, still more preferably from 1:5 to 5:1, e.g. from 1:3 to 3:1.

Whether or not the composition comprises nonionic surfactant, one or more other surfactants may be present. These may be in liquid form or as solid dissolved or dispersed in the substantially non-aqueous liquid component. They may be selected from anionic, cationic and ampholytic detergent surfactants. The anionic surfactants may be incorporated in free acid and/or neutralised from. The cationic surfactant may be neutralised with a counter ion or it may be used to neutralise the at least one ionic ingredient with an exchangeable hydrogen ion.

The compositions of the invention may contain as all or part of component (d), one or more anionic surfactants in salt form, for example one or more of linear alkylbenzene sulphonates, particularly linear alkylbenzene sulphonates having an alkyl chain length of C₈-C₁₅. Other suitable anionic surfactant salts which may be used are well-known to those skilled in the art. Examples include primary and secondary alkyl sulphates, particularly C₈-C₁₅ primary alkyl sulphates; alkyl ether sulphates; olefin sulphonates; alkyl xylene sulphonates; dialkyl sulphosuccinates; and fatty acid ester sulphonates. Sodium salts are generally preferred.

Suitable cationic surfactants include quaternary ammonium fabric softening surfactants, as well as those cationic surfactants which are included in fabric washing compositions for their detergency.

When intended for primarily fabric softening, the composition will therefore preferably contain one or more of the aforementioned fabric softening cationic surfactants. It is preferred that such a cationic softening agent is a water insoluble quaternary ammonium material which comprises a compound having two C₁₂₋₁₈ alkyl or alkenyl groups connected to the nitrogen head group via at least one ester link. It is more preferred if the quaternary ammonium material has two ester links.

A first preferred type of ester-linked quaternary ammonium material is represented by formula (I): 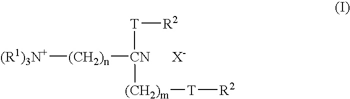
wherein T is 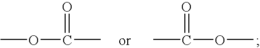
each R¹ group is independently selected from C₁₋₄, alkyl or hydroxyalkyl or C₂₋₄ alkenyl groups; and wherein each R² group is independently selected from C₈₋₂₈ alkyl or alkenyl groups; X⁻ is any suitable anion including a halide, acetate or lower alkosulphate ion, such as chloride or methosulphate, n is 0 or an integer from 1 to 5, and m is an integer from 1 to 5.

Preferred materials of this class such as 1,2 bis[hardened tallowoyloxy]-3-trimethylammonium propane chloride and their method of preparation are, for example, described in U.S. Pat. No. 4,137,180 (Lever Brothers). Preferably these materials comprise small amounts of the corresponding monoester as described in U.S. Pat. No. 4,137,180 for example 1-hardened tallowoyloxy-2-hydroxy 3-trimethylammonium propane chloride.

A second type of ester-linked quaternary ammonium material is represented by the formula (II): 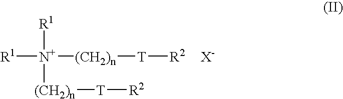
wherein T, R¹, R², n, and X⁻ are as defined above.

Especially preferred materials within this formula are di-alkenyl esters of triethanol ammonium methyl sulphate and N—N-di(tallowoyloxy ethyl) N,N-dimethyl ammonium chloride. Commercial examples of compounds within this formula are Tetranyl® AOT-1 (di-oleic ester of triethanol ammonium methyl sulphate 80% active), AO-1 (di-oleic ester of triethanol ammonium methyl sulphate 90% active), AHT-1 (di-hardened oleic ester of triethanol ammonium methyl sulphate 90% active), L1/90 (partially hardened tallow ester of triethanol ammonium methyl sulphate 90% active), L5/90 (palm ester of triethanol ammonium methyl sulphate 90% active (supplied by Kao corporation) and Rewoquat WE15 (C₁₀-C₂₀ and C₁₆-C₁₈ unsaturated fatty acid reaction products with triethanolamine dimethyl sulphate quaternised 90% active), ex. Witco Corporation.

A third preferred type of quaternary ammonium material is represented by formula (III): 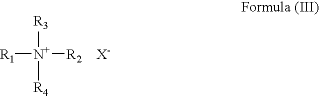
where R₁ and R₂ are C₈₋₂₈ alkyl or alkenyl groups; R₃ and R₄ are C₁₋₄ alkyl or C₂₋₄ alkenyl groups and X⁻ is as defined above.

Examples of compounds within this formula include di(tallow alkyl)dimethyl ammonium chloride, di(tallow alkyl)dimethyl ammonium methyl sulphate, dihexadecyl dimethyl ammonium chloride, di(hardened tallow alkyl)dimethyl ammonium chloride, dioctadecyl dimethyl ammonium chloride and di(coconut alkyl)dimethyl ammonium chloride.

The composition may also comprise one or more solid dissolved and/or dispersed in the substantially non-aqueous liquid. When these are dispersed solids, it is preferred also to include one or more deflocculating agents as described in EP-A-0 266 199. However, when encapsulated in a water-soluble envelope, the composition need not have solid suspending properties.

Component (d) may also comprise anionic surfactant acids and these are well known to those skilled in the art. Examples suitable for use in a liquid composition according to the invention include alkylbenzene sulphonic acid, particularly C₈₋₁₅ linear alkylbenzene sulphonic acids and mixtures thereof. Other suitable surfactant acids include the acid forms of olefin sulphonates, alkyl ether sulphates, alkyl sulphates or alkane sulphonates and mixtures thereof.

A wide range of fatty acids are suitable for inclusion in a liquid composition according to the invention, for example selected from one or more C₈₋₂₄ alkyl or alkenyl monocarboxylic acids. Saturated or unsaturated fatty acids may be used.

Examples of suitable fatty acids include oleic acid, lauric acid or hardened tallow fatty acid.

Other Components

The compositions according to the invention may further comprise one or more ingredients selected from non-ionic or cationic surfactants, builders, polymers, fluorescers, enzymes, silicone foam control agents, free (unencapsulated) perfumes, dyes, bleaches and preservatives.

Some of these materials may be solids which are insoluble in the substantially non-aqueous liquid medium. In that case, they will be dispersed in the substantially non-aqueous liquid medium and may be deflocculated by means of one or more acidic components such as selected from inorganic acids anionic surfactant acid precursors and Lewis acids, as disclosed in EP-A-266 199, as mentioned above.

Unit Dose Forms

Compositions according to the present invention may be encapsulated in a water-soluble envelope such as of a water soluble polymer, for example polyvinylalcohol, thereby to provide unit dose forms. Such encapsulation is well known in the art.

Another suitable unit dose form comprises a refillable water-insoluble container or a water-insoluble pouch intended to be torn open prior to dosing into a wash liquor.

The amount of the substantially non-aqueous liquid cleaning composition is each unit dose envelope or other container may for example be from 10 ml to 100 ml, e.g. from 12.5 ml to 75 ml, preferably from 15 ml to 60 ml, more preferably from 20 ml to 55 ml.

Compositions according to the invention may typically contain:

5-90% by weight of one or more non-surfactant solvents such as hereinbefore described, eg alcohols, diols or polyols, for example monopropylene glycol, monopropylene diol or another organic solvent such as trimethyl propane glycerol and mixtures thereof;

5-80% by weight of one or more surfactants such as anionic, non-ionic and cationic surfactants, preferably any anionic surfactants being neutralised by KOH or by an organic base, and mixtures thereof;

0-15% by weight of water;

0-8% by weight of free perfume;

up to 10% core-in-shell perfume microcapsules; and

optionally, one or more of sequestrants, polymers (functional or rheology modifiers), electrolytes, builders (for laundry detergent applications) and other benefit agents

Processing

The core-in-shell microcapsules can be incorporated into the substantially non-aqueous liquid simple admixture or by admixture of an aqueous slurry of the microcapsules with the non-aqueous liquid, or the microcapsules slurry may be converted to granules first by spray-drying or granulation processes and the capsules included in granular form into the substantially non-aqueous liquid. Another method of incorporating such microcapsules is to entrap them in a polymer matrix and introduce discrete particles made from this matrix as visual cues within the substantially non-aqueous liquids.

It is also possible to dose the slurry continuously in-line in the production or filling of the base substantially non-aqueous liquid detergent composition. When filling a unit dose envelope, the slurry may be dosed into the envelope before, after and/or simultaneously with dosing of the base substantially non-aqueous liquid detergent composition.

In order that the invention may be further understood it will be described with reference to the following non-limiting examples.

### EXAMPLES

1.8 g commercially available melamine-formaldehyde core-in-shell microcapsules (ex PolyChrom, Korea) containing 25% perfume were mixed with 50 g of various model formulations 1-3 (as detailed below) in glass jars.

The glass jars were then closed and stored in an oven at 37° C. for two weeks. After two weeks the samples are taken out of the oven for measurement and the amount of perfume leaked out from the capsules into the liquid was determined by measuring headspace over 5 g of the mixture in a 20 ml headspace vial. A reference headspace measurement was conducted over the same liquids containing equivalent amount of free perfume from the capsules. From the two measurements the percentage of perfume leaked out into the headspace could be calculated. The results for the three detergent liquids are tabulated below.

The LAS used in the examples had the following composition:

Phenyl C9<1%

Phenyl C10 5-16%

Phenyl C11 28-45%

Phenyl C12 28-40%

Phenyl C13 10-30%

Phenyl C14<1%

There is some 2-phenyl isomer content as well (<35% that comes from LAB). All % are weight %

Formulation 1 has a low level of components containing >C6 hydrocarbon chain(s) and a high level of water and MPG

Formulation 2 has a low level of components containing >C6 hydrocarbon chain(s), no water and a high level of MPG

Formulation 3 has a high level of components containing >C6 hydrocarbon chain(s), no water and a high level of MPG and is according to the invention.

As shown in the table below, the least level of perfume is lost to the headspace in formulation 3.

| | Wt % | | |
|---|---|---|---|
| Ingredients | Formulation 1 | Formulation 2 | Formulation 3 |
| Monopropylene glycol | 39 | 77.9 | 33.7 |
| Water | 38.9 | 0 | 0 |

Component with hydrocarbon chain having more than 6 carbon atoms

| | | | |
|---|---|---|---|
| LAS | 10 | 10 | 30 |
| Neodol EO7 (ex Shell) | 10 | 10 | 30 |
| Total | 20 | 20 | 60 |
| Monoethanolamine | 2.1 | 2.1 | 6.3 |
| (for LAS | | | |
| neutralisation) | | | |
| Loss in 2 weeks | 11% | 13% | 3% |

1. A substantially non-aqueous liquid detergent composition which comprises:
(a) perfume microcapsules;
(b) no more than 20%, preferably no more than 15%, still more preferably no more than 10% by weight of water;
(c) from 10% to 70%, preferably from 20% to 60% by weight of water-miscible organic solvent having a molecular weight greater than 70; and
(d) from 30% to 90%, preferably from 40% to 80% by weight of one or more components comprising alkyl or alkenyl chains having more than 6 carbon atoms.

2. A composition according to claim 1, wherein the perfume microcapsules comprise core-in-shell microcapsules.

3. A composition according to claim 2, wherein the core-in-shell perfume microcapsules comprise melamine-formaldehyde microcapsules.

4. A composition according to any preceding claim, wherein the weight ratio of component (d) to component (c) is from 1:10 to 10:1, preferably from 1:6 to 6:1, more preferably from 1:5 to 5:1.

5. A composition according to any preceding claim, wherein the component components having alkyl or alkenyl chains of more than 6 carbon atoms comprise liquid nonionic surfactant.

6. A composition according to any preceding claim comprising one or more additional ingredients selected from detergency builders, enzymes, fluorescers, sequestrants, bleaches, foam inhibitors, dyes and pigments.

7. A composition according to any preceding claim, having a viscosity greater than 200 mPas at a shear rate of 21 s⁻¹.

8. A composition according to any preceding claim, comprising less than 5% by weight of C₁-C₄ alkanols.

9. A water soluble polymer envelope containing a composition according to any preceding claim.

10. An envelope according to claim 9, wherein the composition has a water activity lower than 60%.

11. An envelope according to claim 9 or claim 10, wherein the composition does not have solid-suspending properties.

12. Use of a composition according to any of claims 1 to 8 or an envelope according to any of claims 9 to 11, in a method of washing fabrics in which the substantially non-aqueous liquid detergent composition has been dissolved.

13. Use of perfume microcapsules to include a fragrance component in a substantially non-aqueous liquid detergent composition.
